(19) United States
(12) Patent Application Publication
(10) Pub. No.: US 2004/0047713 A1
(43) Pub. Date: Mar. 11, 2004

(54) Screwed nail

(76) Inventor: Young Jae Jung, Taegu (KR)

Correspondence Address: Jacobson Holman, 400 Seventh Street, N.W., Washington, DC, 20004-2218, US

(21) Appl. No.: 10/237,270

(22) Filed: Sep. 9, 2002

(51) Int. Cl. F16B 15/08

(52) U.S. Cl. 411/453

(57) ABSTRACT

Disclosed is a screwed nail including a nail body having a shank, and a head formed at one end of the shank, the shank having a tip at the other end thereof, wherein the shank has threaded portions respectively formed at opposite sides of a middle portion of the shank, the threaded portions having threads with opposite angles of threading, respectively. It is possible to achieve easy driving of the screwed nail while providing a high fastening force by forming the threaded portions to have opposite angles of threading, and appropriately adjusting those angles of threading, and respective diameters of the threaded portions.

### BACKGROUND OF THE INVENTION

1. Field of the Invention

The present invention relates to a screwed nail, and more particularly to a screwed nail in which threads or steps are formed at the circumferential surface of a nail body to increase the fastening force of the nail.

2. Description of the Related Art

Generally, nails are formed by machining a linear metal body in accordance with a machining process using, for example, a press, thereby forming a nail body having a desired diameter while having a head or without having such a head. Such nails are used as fastening or fixing means for wood and concrete constructions, and various members. In order to obtain an increased fastening force, a screwed or stepped nail has been proposed. Such a screwed or stepped nail is mainly used in building fields: Referring to FIG. 1A, a screwed nail is illustrated. As shown in FIG. 1A, the screwed nail, which is denoted by the reference numeral 1a, includes a nail body 10a, and fastening threads 11 spirally formed on the circumferential surface of the nail body 10a along the axis of the nail body. Referring to FIG. 1B, a stepped nail is illustrated. As shown in FIG. 1B, the stepped nail, which is denoted by the reference numeral 1b, includes a nail body 10b, and anchoring steps 12 protruded from the circumferential surface of the nail body 10b in a direction perpendicular to the axis of the nail body 10b while being arranged along the axis of the nail body 10b. These nails are very useful to fixedly mount shakes on a roof, to fix walls, and to couple members made of different materials.

Although such screwed or stepped nails are widely used in various fields, they have drawbacks.

The screwed nail provides a very high fastening force. However, where an external loosening force or vibration is repeatedly applied to the screwed nail, the threads 11 adapted to increase the fastening force of the nail may rather serve as a loosening guide for slightly loosening the nail with the lapse of time, thereby reducing the strength of the construction to which the nail is applied.

The seriousness of such a problem may be easily recognized by the fact that houses and buildings constructed near areas where take-offs and landings of airplanes frequently occur have an average life considerably shorter than buildings in other areas.

The stepped nail of FIG. 2 does not accompany such a problem. However, this stepped nail has a problem in that it is very difficult to drive the nail into a construction because a plurality of anchoring steps are protruded from the nail in perpendicular to the driving direction of the nail. That is, the power driver tool may be overloaded. Otherwise, the nail may be easily fractured at a recessed portion thereof defined between adjacent steps. As a result, waste of nails is increased.

### SUMMARY OF THE INVENTION

Therefore, the present invention has been made in view of the problems involved with the conventional screwed or stepped nails, and an object of the invention is to provide a nail provided at the circumferential surface thereof with threaded portions respectively having threads of different inclination angles or different pitches so as to eliminate those problems.

Another object of the invention is to provide a nail provided at the circumferential surface thereof with a threaded portion having threads of a desired angle of threading, and a stepped portion, thereby eliminating the problems involved with the conventional screwed or stepped nails while preventing a degradation in strength.

In accordance with one aspect, the present invention provides a screwed nail including a nail body having a shank, and a head formed at one end of the shank, the shank having a tip at the other end thereof, wherein the shank has threaded portions respectively formed at opposite sides of a middle portion of the shank, the threaded portions having threads with opposite angles of threading, respectively.

In accordance with another aspect, the present invention provides a screwed nail including a nail body having a shank, and a head formed at one end of the shank, the shank having a tip at the other end thereof, wherein the shank has threaded portions respectively formed at opposite sides of a middle portion of the shank, the threaded portions having threads with opposite angles of threading, respectively, the angle of threading in one of the threaded portions arranged near the tip being smaller than the angle of threading in the other threaded portion, thereby minimizing generation of stress when the nail is driven into a target construction.

In accordance with another aspect, the present invention provides a screwed nail including a nail body having a shank, and a head formed at one end of the shank, the shank having a tip at the other end thereof, wherein:

the shank has threaded portions respectively formed at opposite sides of a middle portion of the shank, the threaded portions having threads with opposite angles of threading, respectively; and

the middle portion of the shank having a diameter larger than respective diameters of the threaded portions, thereby obtaining an increase in shear strength.

### BRIEF DESCRIPTION OF THE DRAWINGS

The above objects, and other features and advantages of the present invention will become more apparent after a reading of the following detailed description when taken in conjunction with the drawings, in which:

FIGS. 1A and 1B are perspective views respectively illustrating examples of a conventional screwed nail and a conventional stepped nail;

FIG. 2 is a view schematically illustrating the configuration of a screwed nail according to the basic concept of the present invention;

FIG. 3 is a perspective view illustrating a screwed nail according to an embodiment of the present invention;

FIG. 4 is a perspective view illustrating a screwed nail according to another embodiment of the present invention; and

FIG. 5 is a view illustrating a screwed/stepped nail according to another embodiment of the present invention, and a dice for manufacturing the nail.

### DESCRIPTION OF THE PREFERRED EMBODIMENTS

Now, the present invention will be described in detail with reference to the annexed drawings.

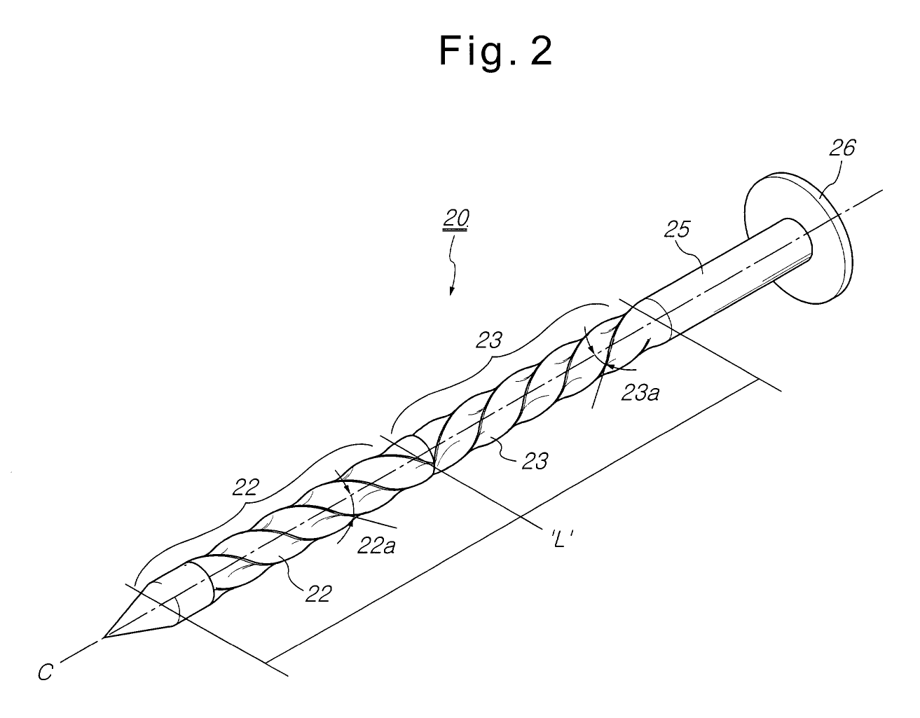

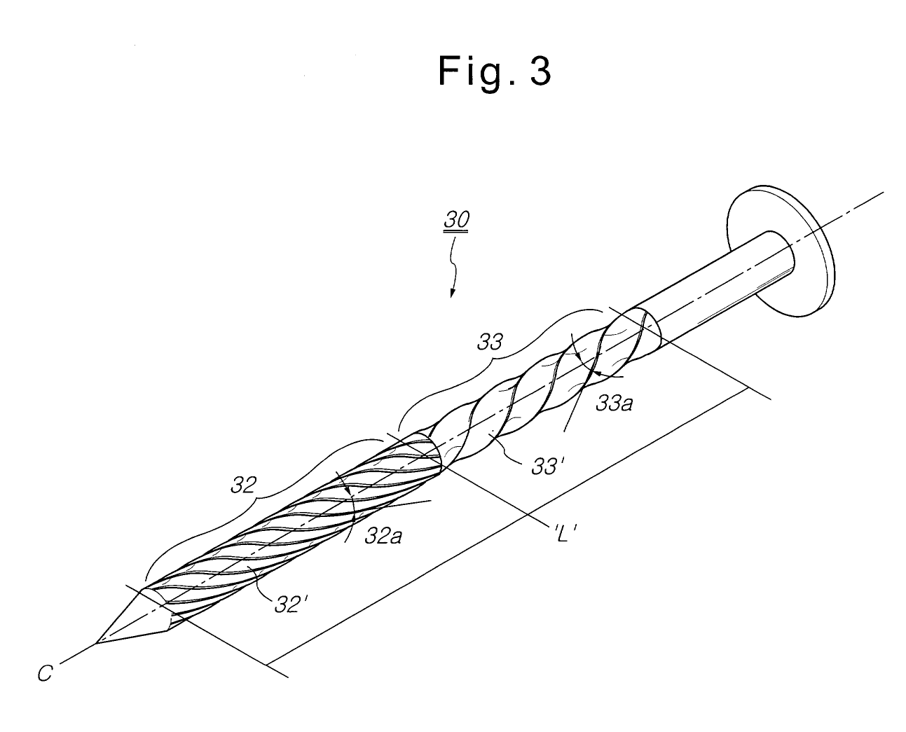

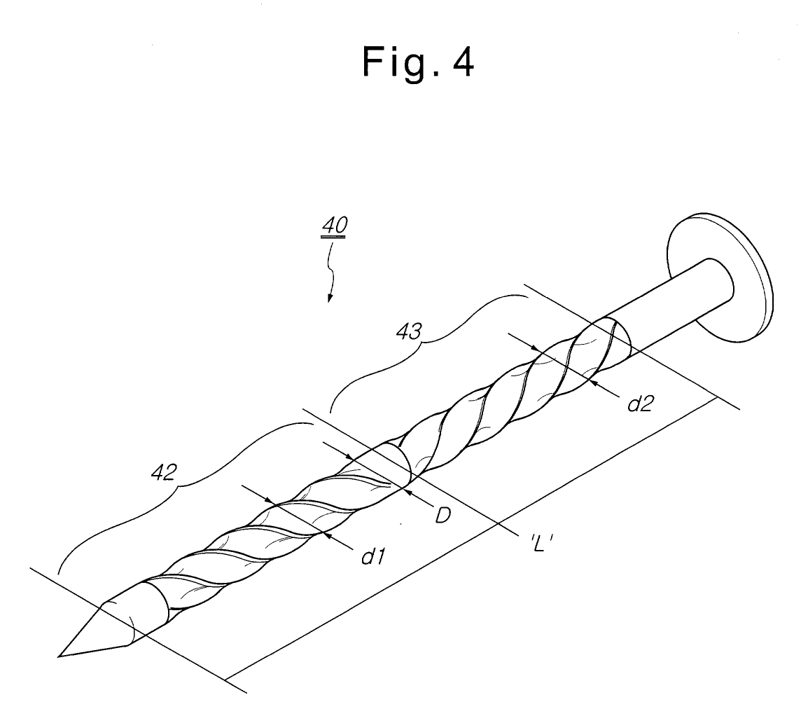

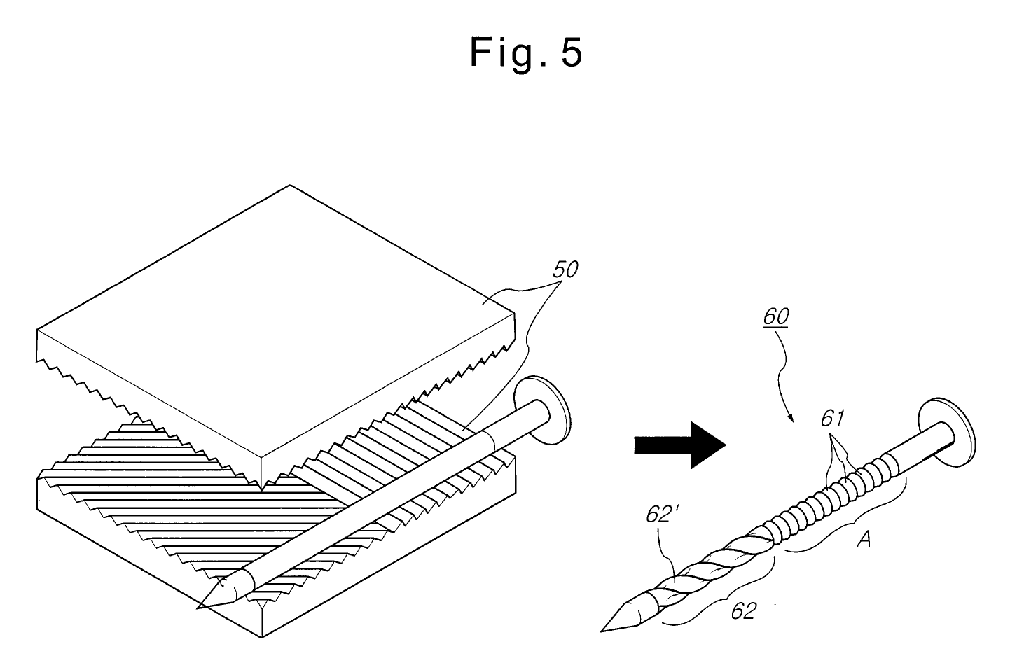

FIG. 2 schematically illustrates the configuration of a screwed nail according to the basic concept of the present invention. FIG. 3 is a perspective view illustrating a screwed nail according to an embodiment of the present invention. FIG. 4 is a perspective view illustrating a screwed nail according to another embodiment of the present invention. FIG. 5 illustrates a screwed/stepped nail according to another embodiment of the present invention, and a dice for manufacturing the nail.

Referring to FIG. 2, a screwed nail according to the basic concept of the present invention is illustrated. As shown in FIG. 2, the screwed nail denoted by the reference numeral 20 includes a nail body 21 having a shank 25 formed with threaded portions 22 and 23, and a head 26.

The threaded portions 22 and 23 are symmetrically formed with respect to a boundary line L passing through a middle portion of the shank 25. The threaded portions 22 and 23 have threads 22′ and 23′ with opposite angles of threading 22a and 23a, respectively.

That is, where the threads 22′ of the threaded portion 22 extend spirally, for example, in a clockwise direction, the threads 23′ of the threaded portion 23 extend spirally in a counterclockwise direction. Thus, the angles of threading 22a and 23a are opposite to each other.

The angles and pitches of the threads 22a and 23a are appropriately determined by the material of the screwed nail 20, and the purpose of use and material of the construction to which the screwed nail 20 is to be applied.

Where the screwed nail 20 is driven into a target construction using a power tool adapted to strike the head of the screwed nail 20, the material, for example, wood, of the target construction is introduced into valleys defined in the threaded portions 22 and 23 while being fractured as it comes into contact with those threaded portions 22 and 23, so that it is threadedly coupled with the threads 22′ and 23′ of the screwed nail 20.

The threads 22′ and 23′ of the threaded portions 22 and 23 have opposite angles of threading 22a and 23a, respectively. Accordingly, even though vibration is repeatedly applied to the screwed nail 20, there is no possibility of loosening of the screwed nail 20 because the vibration not only serves to generate a loosening force at one of the threaded portions 22 and 23, but also serves to generate a fastening force at the other threaded portion. Thus, the screwed nail 20 is not loosened even after a prolonged use thereof.

Referring to FIG. 3, a screwed nail having an improved nail configuration according to another embodiment of the present invention is illustrated.

As shown in FIG. 3, the screwed nail denoted by the reference numeral 30 has threaded portions 32 and 33 having threads 32′ and 33′ with opposite angles of threading 32a and 33a, respectively. The threads 32′ of the threaded portion 32 have an angle of threading considerably smaller than that of the threads 33′ of the threaded portion 33.

In accordance with this configuration, the driving of the screwed nail 30 into a target construction can be easily achieved. In this case, the possibility of fracture of the screwed nail 30 is minimized. Other effects provided by the screwed nail 30 are identical to those of the above described embodiment.

Referring to FIG. 4, a screwed nail having a further improved nail configuration according to another embodiment of the present invention is illustrated.

After conducting experiments, the inventor found that the possibility of fracture of the screwed nail when being struck by a power driver tool is highest at the nail portion corresponding to the boundary L between the threaded portions because of a reduction in shear strength caused by the geometrical shape at that nail portion.

Taking into consideration this fact, at the nail portion corresponding to the boundary L between threaded portions 42 and 43 having diameters d1 and d2, a portion having a diameter D larger than the diameters d1 and d2 is formed, thereby achieving a considerable increase in shear strength.

In accordance with this configuration, it is possible to prevent the screwed nail 40 from being fractured at its middle portion when being struck by a power tool, while allowing a smooth driving of the screwed nail 40 and obtaining desired effects.

The screwed nail of the present invention can be easily manufactured using a dice 50 shown in FIG. 5. This manufacture can be readily appreciated by those skilled in the art, and so no further description thereof will be given.

Referring to FIG. 5, a screwed nail having a configuration according to another embodiment of the present invention is illustrated.

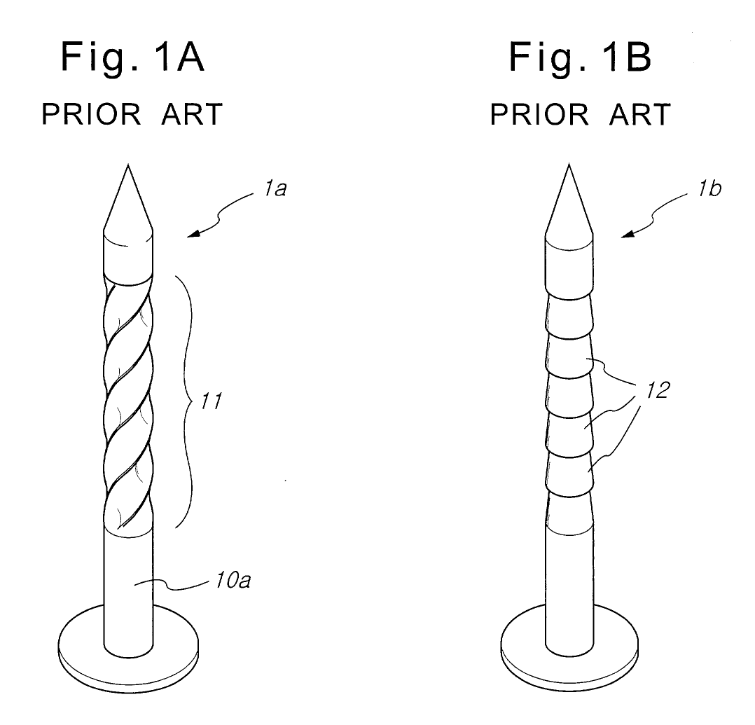

The configuration of FIG. 5 is adapted to allow easy driving of the nail while achieving an increase in strength. As shown in FIG. 5, the nail denoted by the reference numeral 60 is provided at an upper shank portion thereof with an anchoring portion A having a plurality of anchoring steps 61 similar to those of the conventional stepped nail shown in FIG. 1A. The nail 60 is also provided at a lower shank portion thereof with a threaded portion 62 having threads 62′ with a desired angle of threading 62a.

In accordance with this configuration, the nail 60 can be easily driven into a target construction by virtue of its threaded portion 62 arranged near its tip portion. In the state in which the threaded portion 62 of the nail 60 is driven into the target construction, the anchoring steps 61 are subsequently driven into the target construction. Accordingly, it is possible to prevent the nail 60 from being fractured at its anchoring portion A while obtaining an increased fastening force, as compared to the conventional stepped nail of FIG. 1A.

As apparent from the above description, the present invention provides a screwed nail including a nail body having different threaded portions. In accordance with the present invention, it is possible to achieve easy driving of the screwed nail while providing a high fastening force by forming the threaded portions to have opposite angles of threading, and appropriately adjusting those angles of threading, and respective diameters of the threaded portions.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A screwed nail including a nail body having a shank, and a head formed at one end of the shank, the shank having a tip at the other end thereof, wherein the shank has threaded portions respectively formed at opposite sides of a middle portion of the shank, the threaded portions having threads with opposite angles of threading, respectively.

2. The screwed nail according to claim 1, wherein the angle of threading in one of the threaded portions arranged near the tip being smaller than the angle of threading in the other threaded portion, thereby minimizing generation of stress when the nail is-driven into a target construction.

3. The screwed nail according to claim 1, wherein the middle portion of the shank having a diameter larger than respective diameters of the threaded portions, thereby obtaining an increase in shear strength.

4. The screwed nail according to any one of claims 1 to 3, wherein the threaded portions have different angles of threading and different pitches, respectively.

5. A screwed nail including a nail body having a shank, and a head formed at one end of the shank, the shank having a tip at the other end thereof, wherein the shank has a threaded portion formed at one side of the shank near the tip while having threads with a desired angle of threading, and an anchoring portion formed at the other side of the shank near the head while having anchoring steps protruded from a circumferential surface of the shank in a direction perpendicular to an to an axis of the nail body.
